(19) United States
(12) Patent Application Publication
(10) Pub. No.: US 2024/0017305 A1
(43) Pub. Date: Jan. 18, 2024

(54) Entry-Less Railroad Tank Car Cleaning System

(71) Applicant: Proterra Energy Solutions Inc., Airdrie (CA)

(72) Inventors: Evan INGRAM, Airdrie (CA); Bradley CRUIKSHANK, Airdrie (CA)

(73) Assignee: Proterra Energy Solutions Inc., Airdrie (CA)

(21) Appl. No.: 18/351,003

(22) Filed: Jul. 12, 2023

Related U.S. Application Data
(60) Provisional application No. 63/388,468, filed on Jul. 12, 2022.

(51) Int. Cl. B08B 9/093; B08B 13/00; B08B 9/46; B61K 11/00; G06T 7/00; G06V 20/59

(52) U.S. Cl. CPC B08B 9/093; B08B 13/00; B08B 9/46; B61K 11/00; G06T 7/0002; G06V 20/59; B08B 2209/08; G06T 2207/10064; G06T 2207/30268

(57) ABSTRACT

A railroad tank car cleaning system that does not require a human to enter the tank car is disclosed herein. The system may include a cannon assembly secured to a tank of a railroad tank car at an opening of a manway hatch of the tank. The cannon assembly may include an adapter configured to seal the opening of the manway hatch and a hydraulic cannon configured to extend within an interior of the tank. The system may further comprise a controller configured to automatically control movement and operation of the hydraulic cannon during cleaning according to one or more cleaning profiles specifying a pre-programmed duration and/or pattern of movement. The cleaning profiles used for a given tank may be selected by a user or automatically determined based on knowledge of the tank.

### RELATED APPLICATIONS

This application claims priority to U.S. Provisional Patent Application No. 63/388,468, filed Jul. 12, 2022, the content of which is incorporated herein by reference in its entirety.

### FIELD OF THE INVENTION

The present invention relates to the railway industry and, more particularly, to systems for cleaning the inside of railroad tank cars.

### BACKGROUND OF THE INVENTION

Railroad tank cars are frequently used to transport a variety of liquid or gaseous commodities, such as crude oil, acid, fertilizer, polymer, food grain products, and/or other goods or resources. Over time, residual material, such as sludge or particulates, from these goods or resources may settle down on the bottom of the tanks reducing the storage capacity, lowering product quality, and increasing shipping cost. The residual material at the bottom of the tank is commonly referred to as the tank heel.

Conventional tank cleaning processes can be expensive and risky operations. Common methods for cleaning the inside of a railroad tank car involves transporting the tank to an off-site facility or mobilizing a cleaning crew to come on-site. Crew members then need to physically enter the confined interior space, which may pose serious health and safety risks. Crew members also often need to bring with them various pieces of equipment. For example, crew members may need to bring into the tank car hazmat equipment, supplied oxygen, and/or cleaning tools, such as shovels, buckets, and high-power pressure washers. Bringing this equipment into the interior of the railroad tank car can cause significant damage to the tank liner and may further require transporting the waste to a disposal yard, which only adds to the cost and cleaning time.

An integrated tank cleaning system that can be utilized without requiring crew members to physical enter the tank car or the tank car being transported to an off-site facility would be a significant improvement over conventional railroad tank car cleaning processes.

### SUMMARY OF THE INVENTION

Aspects of this disclosure relate to various embodiments of a railroad tank car cleaning system that does not require a human to enter the tank car. In various embodiments, a railroad tank car cleaning system is described that includes a cannon assembly secured to a tank of a railroad tank car at an opening of a manway hatch of the tank. In various embodiments, the cannon assembly may include an adapter configured to seal the opening of the manway hatch and a hydraulic cannon configured to extend within an interior of the tank. The hydraulic cannon may include at least a nozzle for pressure cleaning the interior of the tank and a camera for remotely visualizing and/or monitoring the interior of the tank. In various embodiments, the railroad tank car cleaning system may further comprise a controller configured to automatically control movement and operation of the hydraulic cannon during cleaning according to one or more cleaning profiles. For example, the cleaning profiles may each specify a pre-programmed duration and/or pattern of movement for the hydraulic cannon to clean the interior of the tank. The one or more cleaning profiles used for a given tank may be selected by a user or automatically determined based, for example, on the size of the tank, the shape of the tank, and/or a material that was stored in the tank. In various embodiments, the railroad tank car cleaning system may be portable in the sense that a vehicle may be used to transport the system between railroad tank cars within a railyard. In some embodiments, the railroad tank car cleaning system may further include a filtration unit that is configured to filter and recirculate liquid drained from the tank during cleaning and may be transported between railroad tank cars with the cannon assembly.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIGS. 1A-B depict perspective views of an example integrated tank cleaning system affixed to a tank of a railroad tank car, according to one or more aspects described herein;

FIG. 2 depicts a schematic view of an example integrated tank cleaning system, according to one or more aspects described herein;

FIGS. 3A-C depict various views of an example cannon adapter assembly of an integrated tank cleaning system, according to one or more aspects described herein;

FIG. 4 depicts an exploded view of an example cannon adapter assembly of an integrated tank cleaning system, according to one or more aspects described herein;

FIGS. 5-7 depict detailed views of various components of an example cannon adapter assembly of an integrated tank cleaning system, according to one or more aspects described herein;

FIG. 8 depicts a perspective view of an example mobile enclosure for cannon adapter assembly, according to one or more aspects described herein; and

FIG. 9 depicts a flow diagram of an example method for removing residual material from a railcar utilizing an integrated tank cleaning system, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. These aspects are indicative, however, of but a few of the various ways in which the principles of the invention may be employed and the present invention is intended to include all such aspects and their equivalents. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

The invention described herein relates to systems and methods for cleaning the inside of a railroad tank car without requiring personnel to physically enter the tank car. The systems and methods described herein utilize an engineered manway cannon adapter that seals the railcar, preventing fugitive emissions from ventilating into the atmosphere. The manway cannon adapter may be configured to house at least a hydraulic cannon, a light, and a camera that allow for high pressure cleaning with the ability to visually track progress in real-time. In various embodiments, the manway cannon adapter is outfitted with one or more of sealed hydraulic ports, emission testing ducting, lifting lugs, a vacuum breaker valve, a pressure relief device, and/or other components that enhance cleaning efficiency and operator safety. In various embodiments, the manway cannon adapter, in conjunction with a cannon skid and filtration unit, allow for mobile or fixed facility cleaning of any railcar commodity.

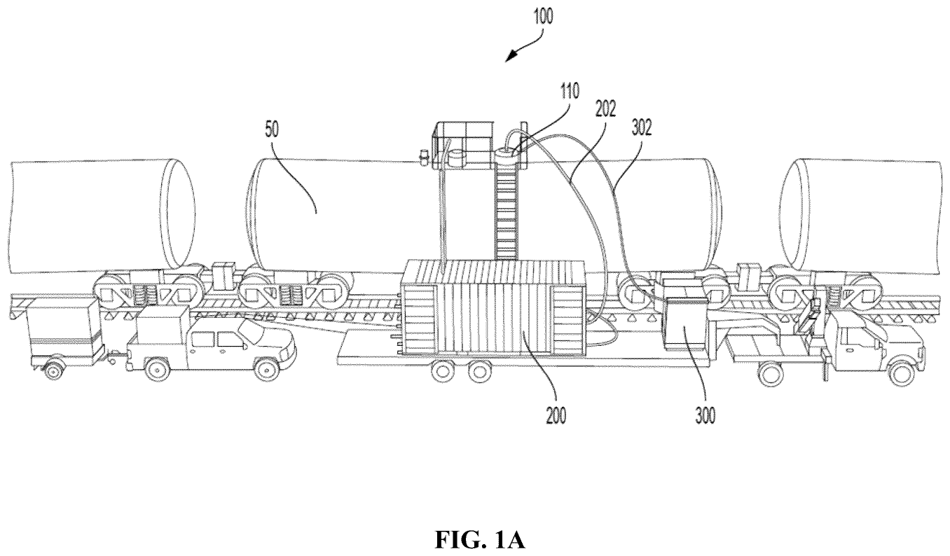

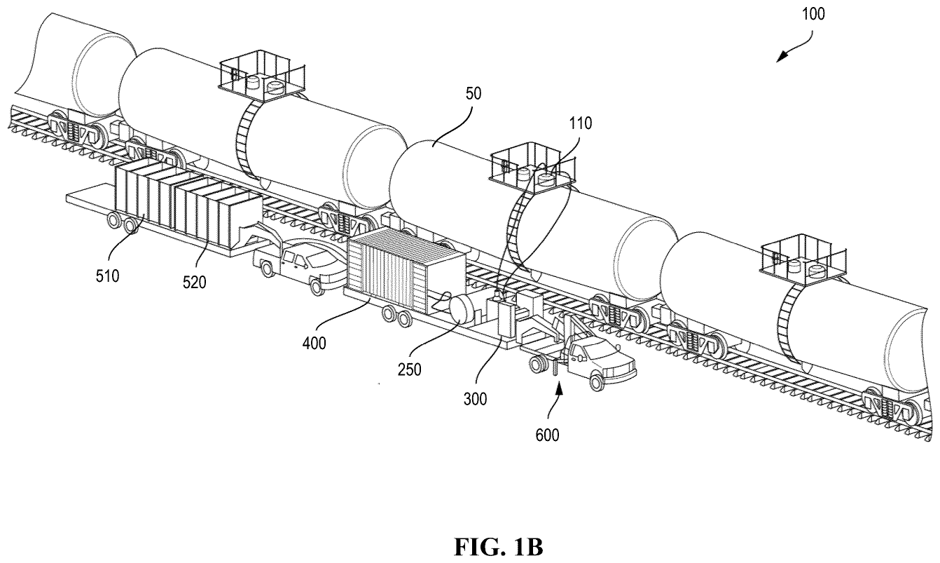

FIGS. 1A-B depict perspective views of an example integrated tank cleaning system 100 affixed to a tank 50 of a railroad tank car, according to one or more aspects described herein. In various embodiments, integrated tank cleaning system 100 (which may be referred to interchangeably herein as railroad tank car cleaning system 100) may include a cannon adapter assembly 110 (also interchangeably referred to herein as a “cannon assembly”) comprising a hydraulic cannon configured to pressure clean the inside of a tank 50. In various embodiments, cannon adapter assembly 110 may be configured to be removably secured or otherwise securely attached to a tank 50 of a railroad tank car at an opening of tank 50. For example, cannon adapter assembly 110 may be configured to be inserted into and seal the opening of a manway hatch of tank 50. When cannon adapter assembly 110 is installed on or attached to a tank 50 of a railroad tank car, the hydraulic cannon of cannon adapter assembly 110 may be configured to extend within an interior of tank 50. In various embodiments, the hydraulic cannon of cannon adapter assembly 110 may be remotely controlled and/or automatically controlled to clean the inside of the tank car without requiring personnel to physically enter the tank car. In various embodiments, the hydraulic cannon of cannon adapter assembly 110 may include or be included with at least a nozzle for pressure cleaning the interior of the tank and a camera for remotely visualizing the interior of the tank.

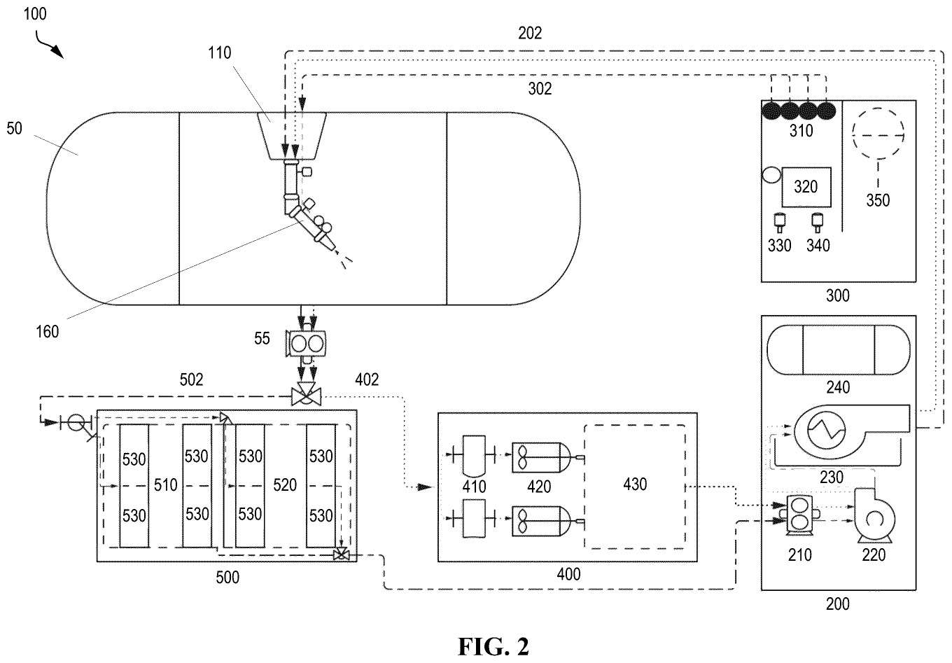

In various embodiments, integrated tank cleaning system 100 may include an operating system connected to and configured to interface with cannon adapter assembly 110. In various embodiments, an operating system of integrated tank cleaning system 100 may include a seacan 200, a skid 300, and/or one or more other components physically connected and/or communicatively linked to cannon adapter assembly 110. For example, in some embodiments, integrated tank cleaning system 100 may further include a pump and heat source 250, a wastewater filtration unit 400, a diesel holding tank 510, a caustic holding tank 520, and/or one or more other components. In some embodiments, the components of integrated tank cleaning system 100 may be variously combined or contained within a single component (such as seacan 200) or the components may be separated and stored in multiple separate storage units or containers. For example, in some embodiments, pump and heat source 250 may be included within or connected to seacan 200. As another non-exclusive example, diesel holding tank 510 and caustic holding tank 520 may be separate and/or included within product blending insulated tank skid 500 described further herein with respect to FIG. 2.

In some embodiments, cannon adapter assembly 110 may be connected to seacan 200 via a discharge hose 202. In some embodiments, cannon adapter assembly 110 may be connected to skid 300 via one or more hydraulic hoses 302. In some embodiments, the operating system of integrated tank cleaning system 100 may be mobile and configured to be moved within a railyard to enable integrated tank cleaning system 100 (and cannon adapter assembly 110) to be moved to individual railroad tank cars for cleaning as opposed to requiring railroad tank cars to be moved to an equipped facility. For example, in some embodiments, integrated tank cleaning system 100 may include a picker truck 600 or other vehicle configured to transport one or more components of integrated tank cleaning system 100. In such embodiments, the operating system of integrated tank cleaning system 100 and various other components may be configured to be moved via vehicle 600 and positioned within a proximity of tank 50 of a railroad tank car to be cleaned. For example, unlike conventional solutions, the filtration unit 400 of railroad tank car cleaning system 100 may be configured to be transported between railroad tank cars with cannon assembly 100 and various other components of railroad tank car cleaning system 100. In other embodiments, integrated tank cleaning system 100 may be installed in a facility and configured to clean railroad tank cars positioned within the facility.

FIG. 2 depicts a schematic view of example integrated tank cleaning system 100, according to one or more aspects described herein. As depicted in FIG. 2, integrated tank cleaning system 100 may include cannon adapter assembly 110, seacan 200, skid 300, and/or one or more other components. In various embodiments, integrated tank cleaning system 100 may include a controller configured to automatically control or facilitate remote control of the cannon assembly 110 within tank 50, for example, using hydraulic actuators. For example, the controller may be configured to automatically control movement and operation of the hydraulic cannon during cleaning according to one or more cleaning profiles, as described further herein. In various embodiments, the controller of integrated tank cleaning system 100 may include or comprise one or more processors configured to provide information processing capabilities in integrated tank cleaning system 100. For example, the one or more processors may comprise a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. The processor(s) of the controller may be configured to execute one or more computer readable instructions. In various embodiments, the controller of integrated tank cleaning system 100 may be included within one or more components of integrated tank cleaning system 100 described herein (such as, e.g., in cannon adapter assembly 110, seacan 200, skid 300, and/or one or more other components) or may be located separately and/or remotely from the one or more other components of integrated tank cleaning system 100 described herein.

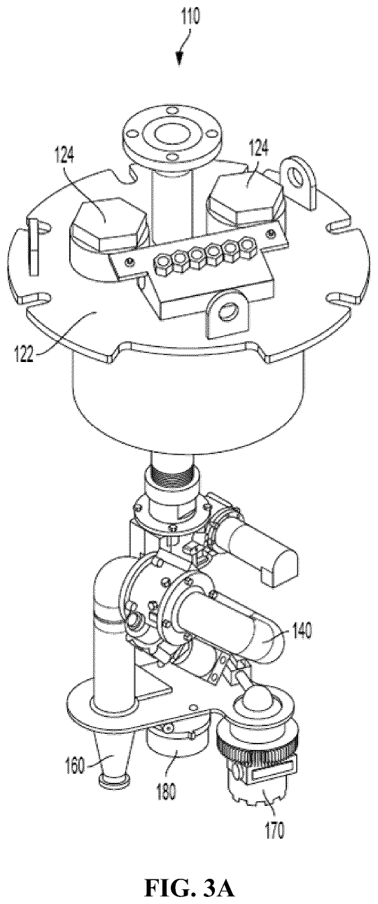

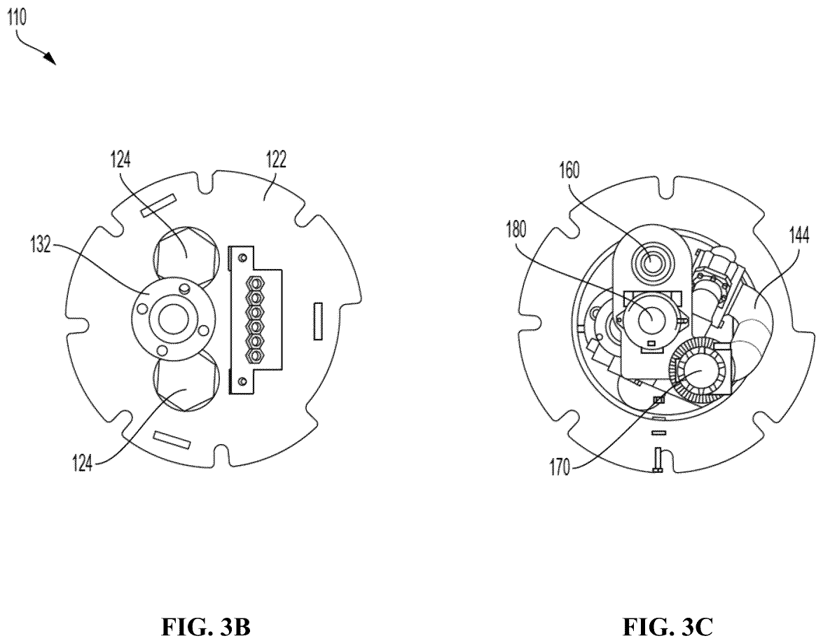

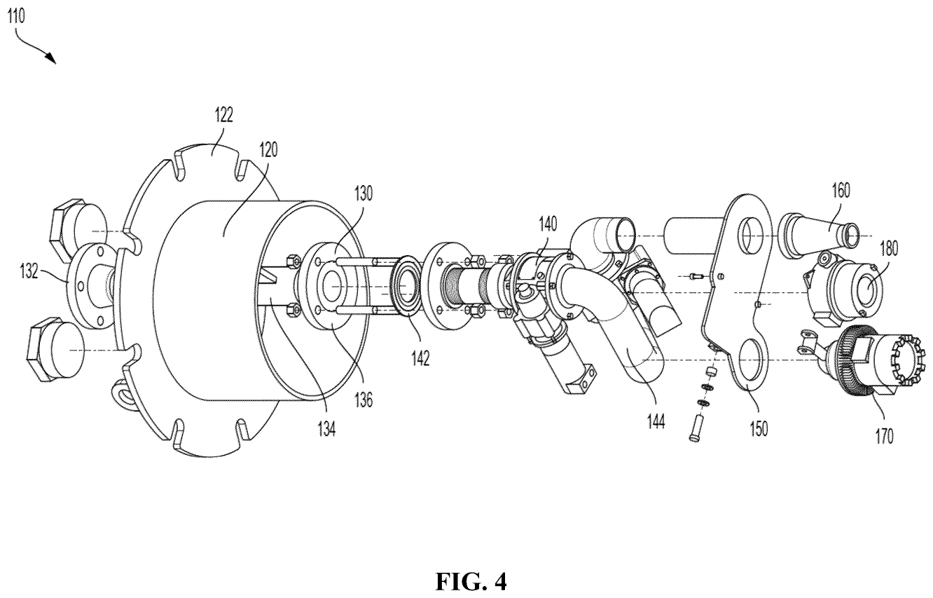

In various embodiments, cannon adapter assembly 110 may be configured to attach to an opening of tank 50 and extend within the interior of tank 50. In various embodiments, a nozzle 160 of cannon adapter assembly 110 may be configured to spray water, a cleaning solution, and/or other liquids or mixtures of liquids within tank 50. For example, in some embodiments, nozzle 160 of cannon adapter assembly 110 may be configured to direct pressurized cleaning solution to a target surface within tank 50 to remove residual material within tank 50 or otherwise clean the inside of tank 50. In various embodiments, cannon adapter assembly 110 may include a hydraulic inlet, a cleaning agent inlet, a spraying mixer, and/or one or more other components, as described herein with respect to FIGS. 3A-C and FIG. 4.

In various embodiments, integrated tank cleaning system 100 may include a pressure unit skid 200, a cannon skid 300, a water purification skid 400, a product blending skid 500, and/or one or more other components. The components of integrated tank cleaning system 100 may be variously combined or contained within one or multiple components or the components may be separated and/or included in other components. In various embodiments, pressure unit skid 200 may be configured to provide pressurized cleaning solution to cannon adapter assembly 110 for discharge within tank 50. In various embodiments, pressure unit skid 200 may be the same as or similar to seacan 200. As described herein, pressure unit skid 200 may be connected to cannon adapter assembly 110 via a pressure discharge hose 202. In some embodiments, pressure unit skid 200 may comprise an 8′ by 20′ skid. In some embodiments, pressure unit skid 200 may include pump and heat source 250. In various embodiments, pressure unit skid 200 may include a gear pump 210, a centrifugal pump 220, an oil burner 230, a fuel tank 240, and/or one or more other components.

In various embodiments, cannon skid 300 may be configured to provide electrical and hydraulic power to cannon adapter assembly 110 and allow cannon adapter assembly 110 to be automatically or remotely controlled via a controller of integrated tank cleaning system 100. Among other things, cannon skid 300 (and integrated tank cleaning system 100 generally) facilitate the cleaning of the interior of a tank 50 of a railroad tank car without requiring a human to enter the tank car. In various embodiments, cannon skid 300 may be the same as or similar to skid 300 depicted and described with respect to FIGS. 1A-B. In some embodiments, cannon skid 300 may be connected to cannon adapter assembly 110 via one hydraulic and electrical umbilical cords (which may include hydraulic hoses 302 described herein). In some embodiments, cannon skid 300 may comprise a 6′ by 4′ by 6′ skid. In various embodiments, cannon skid 300 may include hydraulic cable reels 310, a junction box 320, a power pack 330, an electric motor 340, a railcar cannon transportation unit 350, and/or one or more other components.

In various embodiments, water purification skid 400 may be configured to provide filtration and recirculation functionality to liquid drained from or received from tank 50 during cleaning. In various embodiments, water purification skid 400 may comprise or be the same as or similar to water filtration unit 400 depicted and described with respect to FIGS. 1A-B. In some embodiments, water purification skid 400 may be connected to tank 50 via water hose 402. In some embodiments, water purification skid 400 may comprise an 8′ by 20′ insulated skid. In various embodiments, water purification skid 400 may include filter pots 410, media vessels 420, one or more water tanks 430, and/or one or more other components.

In various embodiments, product blending skid 500 may be configured to collect, filter, and store waste product received from tank 50 when tank 50 is drained before, during, or after the cleaning process. In some embodiments, product blending skid 500 may comprise an 8′ by 20′ insulated tank skid. In various embodiments, product blending skid 500 may include a diesel supply 510, a caustic supply 520, and/or one or more other components. In some embodiments, diesel supply 510 and caustic supply 510 may be the same as or similar to diesel holding tank 510 and caustic holding tank 520, respectively, depicted and described with respect to FIGS. 1A-B. In some embodiments, diesel supply 510 and/or caustic supply 520 may include baffles 530 to direct the flow of liquid or gas in and/or out of diesel supply 510 and/or caustic supply 520. In some embodiments, product blending skid 500 may be connected to tank 50 via diesel hose 502.

In various embodiments, integrated tank cleaning system 100 may include a discharge pump to pressurize liquid provided to cannon adapter assembly 110 via discharge hose 202. For example, a discharge pump may be configured to pressurize cleaning solution to be provided to cannon adapter assembly 110 via discharge hose 202. The pressurized cleaning solution may then be ejected from a nozzle 160 of cannon adapter assembly 110 and directed at a target surface or the heel of tank 50. In some embodiments, the flow rate of liquid (e.g., cleaning solution) from nozzle 160 may be in a range from about 500 liters per minute to about 1500 liters per minute. Such pressurized cleaning solution may impact the tank heel or the target surface of tank 50 at a pressure in a range from about 1035 kPa to about 2070 kPa depending on the diameter of nozzle 160, the flow rate of the pressurized cleaning solution, and/or one or more other factors.

In various embodiments, integrated tank cleaning system 100 may comprise a filtration system configured to recirculate liquid released from an outlet valve of tank 50. For example, residual material separated from the heel or a target surface of tank 50 may be filtered when released from an outlet valve and collected via water hose 402 and/or another hose configured to receive liquid and/or other material discharged from tank 50. In various embodiments, integrated tank cleaning system 100 may comprise a transfer pump 55 configured to cause to pump liquid and/or other material (e.g., residual mixed solution) from an outlet valve of tank 50. In some embodiments, transfer pump 55 may be configured to pump liquid via water hose 402 into water filtration unit 400. In some embodiments, transfer pump 55 may be configured to pump liquid via diesel hose 502 and/or another hose into diesel supply 510, caustic supply 520, and/or one or more other holding tanks.

In various embodiments, water purification skid 400 may include filter pots 410 configured to filter liquid from an outlet valve on tank 50 before passing the filtered liquid to one or more media vessels 420, water tanks 430, and/or other holding tanks. The filter pots 410 may be configured to remove particulate materials and other impurities from the liquid or other residual material received via the suction hose from tank 50. In some embodiments, these impurities may include by-products of the previously-stored solution within one or more holding tanks and/or other particulates that may be formed during the cleaning process. In some embodiments, the holding tanks may include a debulking holding tank and a final clean holding tank. In some embodiments, the transfer pump 55 may be configured to provide force to aid in the debulking and/or mixing of the liquid within the one or more holding tanks.

In various embodiments, liquid collected in the one or more holding tanks may be recirculated and provided to cannon adapter assembly 110. For example, discharge hose 202 may be configured to receive recycled liquid from the one or more holding tanks and provide the recycled liquid to cannon adapter assembly 110. In various embodiments, the water hose 402, the transfer pump 55, the discharge hose 202, and/or one or more other components may be configured to provide a desired recirculation rate to the nozzle 160 of cannon adapter assembly 110. This recirculation rate may be used to ensure, for example, that a cleaning solution is properly mixed so that variations of concentrations (that result from the chemical reactions) at different points within the cleaning solution are kept at a minimum. In various embodiments, pressure unit skid 200 and/or water purification skid 400 may include a monitoring system comprising one or more media vessel (e.g., media vessels 420) connected with the transfer pump 55, the filter pots 410, and/or one or more other components.

In various embodiments, to obtain the desired temperature of the cleaning solution or other liquid sprayed via nozzle 160 of cannon adapter assembly 110, a heater and/or a cooling fan may be used. In an example embodiment, a flow heat exchanger may be used in order to maintain the liquid to a constant temperature. In some embodiments, the cooling fan may be an active cooling unit (e.g., a refrigeration unit) to provide the desired cooling to the liquid. Any suitable system and/or method of heating and/or cooling the liquid to control the temperature of the liquid may be utilized, and all such systems and/or methods are fully intended to be included within the scope of the embodiments described herein.

FIGS. 3A-C and FIG. 4 depict various views of an example cannon adapter assembly 110 of an integrated tank cleaning system 100, according to one or more aspects described herein. For example, FIG. 3A depicts a perspective view of an example cannon adapter assembly 110, FIG. 3B depicts a top view of an example cannon adapter assembly 110, FIG. 3C depicts a bottom view of an example cannon adapter assembly 110, and FIG. 4 depicts an exploded view of an example cannon adapter assembly 110. In various embodiments, cannon adapter assembly 110 may include an adapter 120, a monitor sub-assembly 140, and/or one or more other components. In various embodiments, adapter 120 may be configured to seal the opening of the manway hatch of tank 50.

In various embodiments, adapter 120 includes an adapter plate 122, pressure relief ports 124, an extending stem 130, and/or one or more other components. In some embodiments, adapter 120 may include a substantially cylindrical adapter body. For example, the substantially cylindrical adapter body may be coaxially and/or slidably received within an opening of tank 50 and configured to bear against any appropriate type of sealing. In other embodiments, adapter 120 may be a non-circular, rectangular, polygonal, triangular, oval, or a combination of any appropriate shape to facilitate the one or more structural units.

In some embodiments, adapter plate 122 may be configured to provide an interface to monitor sub-assembly 140. In some embodiments, pressure relief ports 124 may be provided at adapter plate 122 via a selectively detachable connection. In various embodiments, pressure relief ports 124 may be connected to a vacuum breaker valve and/or a pressure relief device.

In various embodiments, extending stem 130 of adapter 120 may include a stem base 132, a stem body 134, a flanged portion 136, and/or one or more other components. Stem body 134 may be configured to extend away from stem base 132 along an axis perpendicular to a side of tank 50 to which cannon adapter assembly 110 is affixed and from which cannon adapter assembly 110 extends. In various embodiments, monitor sub-assembly 140 may be configured to be mounted to adapter 120 via extending stem 130. In some embodiments, the extending stem 130 may be mated to and received within an opening of the adapter 120. In some embodiments, stem body 134 may be include a flanged portion 136 configured to receive a mounting washer 141 and/or a mounting fastener 142 of monitor sub-assembly 140 to securely fasten monitor sub-assembly 140 to adapter 120 via extending stem 130.

In various embodiments, monitor sub-assembly 140 may include a selectively rotatable tubing sub-assembly 144, a mounting bracket 150, a nozzle 160, a light assembly 170, a camera assembly 180, and/or one or more other components. Selectively rotatable tubing sub-assembly 144 may be configured to attach nozzle 160, light assembly 170, camera assembly 180, and/or one or more other components via monitoring bracket 150 to adapter 120. In some embodiments, selectively rotatable tubing sub-assembly 144 may be selectively rotatable to establish a predetermined projecting angle from the railcar. In various embodiments, selectively rotatable tubing sub-assembly 144 may be a 3-axis rotational device configured to be remotely controlled and/or automatically controlled to direct nozzle 160 within tank 50. In some embodiments, nozzle 160 may include a pulsation insert and/or a directional insert. The pulsation insert may be configured to generate a pulsation/oscillation of pressurized cleaning solution by inserting a mechanical device into the nozzle. The directional insert may be configured to change a two-dimensional direction and/or three-dimensional rotation of the pressurized cleaning solution by inserting a mechanical device into the nozzle. In various embodiments, light assembly 170 may be configured to assist camera assembly 180 in capturing images of the inside of tank 50. Light assembly 170 may comprise a flashlight, a spotlight, and/or one or more other types of lighting equipment to be used to support camera assembly 180. Camera assembly 180 may comprise one or more cameras and/or other types of image capturing devices.

In various embodiments, monitor sub-assembly 140 may include fluorescence-based imaging functionality to monitor residual material on a target surface of tank 50. For example, monitor sub-assembly 140 may comprise a light source emitting light for illuminating the target, the emitted light including at least one wavelength or wavelength band causing at least one residual material associated with the target to fluoresce, and a light detector for detecting the fluorescence. The operating system of integrated tank cleaning system 100 may then identify a target area where residual material within tank needs to be removed. In some embodiments, nozzle 160 of cannon adapter assembly 110 may be configured to direct pressurized cleaning solution to a target surface within tank 50 to remove residual material within tank 50 or otherwise clean the inside of tank 50.

In various embodiments, an operating system of integrated tank cleaning system 100 may include a controller configured to enable cannon adapter assembly 110 to be remotely controlled and/or automatically controlled. In some embodiments, the controller may be configured to monitor residual material on a target surface of tank 50 via monitoring device 144, adjust valves of the exhaust pump or the discharge pump, and regulate ejecting parameters for liquid from nozzle 160. For example, in some embodiments, the controller may be configured to control various aspects of cannon adapter assembly 110 or the operating system of integrated tank cleaning system 100 based on images captured by camera assembly 180. In some embodiments, using images captured by camera assembly 180, the controller may be configured to automatically halt ejection of liquid from nozzle 160 when the amount of residual material on a target surface of tank 50 is below a threshold amount. Any appropriate controlling configuration regarding automatic and/or manual operation is contemplated and is not limited in this regard.

In some embodiments, the controller may be configured to automatically control the position of nozzle 160 via selectively rotatable tubing sub-assembly 144 based on pre-programmed patterns, cleaning modes, and/or cleaning profiles (which may specify one or more pre-programmed durations and/or patterns of movement for the hydraulic cannon for cleaning the interior of the tank). For example, one or more pre-programmed patterns, cleaning modes, and/or cleaning profiles may be stored in electronic storage accessible by the operating system of integrated tank cleaning system 100. In some embodiments, the one or more pre-programmed patterns, cleaning modes, and/or cleaning profiles to be used may be automatically selected based on the size of tank 50, the shape of tank 50, the material stored in tank 50, and/or one or more other factors.

In other embodiments, the one or more pre-programmed patterns or cleaning modes may be manually or automatically selected for a given tank 50 of a railroad tank car. In various embodiments, cleaning profiles may be utilized that specify at least one pre-programmed duration and/or pattern of movement for the hydraulic cannon for cleaning the interior of the tank. For example, electronic storage accessible by the operating system of integrated tank cleaning system 100 may be configured to store one or more cleaning profiles that define one or more patterns, durations, nozzle cleaning (or ejection) modes, and/or types of inserts (e.g., pulsation insert and/or directional insert) to be used for a given profile. In some embodiments, a user may select a given profile for a tank 50 of a railroad tank car. In some embodiments, the controller of integrated tank cleaning system 100 may be configured to automatically select or determine one or more pre-programmed patterns or cleaning modes for a given tank 50 based on knowledge of a train and/or specific railroad tank car. For example, the controller may be configured to automatically select one or more patterns, durations, ejection modes, and/or types of inserts based on the size of tank the shape of tank 50, the type of tank for tank 50, the material stored in tank 50, and/or one or more other factors.

In an example implementation, the cleaning position of monitor sub-assembly 140 (and nozzle 160) with respect to the tank heel or a target surface of the tank 50 may be programmed by the controller according to the pre-programmed pattern or cleaning mode selected. For example, the cleaning position may be programmed in a horizontal configuration of the tank 50. In some implementations, the pre-programmed pattern or cleaning mode selected may indicate the duration of the cleaning session, the amount of liquid discharged into tank 50, the flow rate of liquid from nozzle 160, the pressure of the liquid emitted from nozzle 160, and/or one or more other adjustable aspects of cannon adapter assembly 110.

In some embodiments, the controller may be configured to automatically determine the cleaning set of profiles to direct pressurized cleaning solution to a target surface within tank 50 to remove residual material within tank 50 or otherwise clean the inside of tank 50. For example, cannon adapter assembly 110 may include one or more vision systems configured to learn and map the interior contours of tank 50, such that one or more cleaning profiles may be automatically determined by the controller. Nozzle 160 of cannon adapter assembly 110 may then be configured to direct pressurized cleaning solution to remove residual material within tank 50 or otherwise clean the inside of tank 50 according to the cleaning profile (or parameters) determined by the controller.

In some embodiments, the controller of integrated tank cleaning system 100 may be configured to use one or more vision systems (e.g., which may include camera assembly 180) to identify cleaning-related characteristics (e.g., area covered, concentration/density level, or type) of residual material within tank 50 and determine one or more cleaning profile (or associated parameters, such as pattern, duration, nozzle ejection mode, and/or type of inserts) to direct pressurized cleaning solution to a target surface within tank 50 when removing residual material within tank 50 or otherwise cleaning the inside of tank 50. For example, the operating system of integrated tank cleaning system 100 may identify area covered by residual materials using fluorescence-based imaging. In such an embodiment, cannon adapter assembly 110 may be configured to direct pressurized cleaning solution to remove a wider (or bigger) area covered by residual material and then remove a narrower (or smaller) area covered by residual material within tank 50. In an alternative embodiment, cannon adapter assembly 110 may be configured to direct a first pressurized cleaning solution to remove a first residual material (e.g., a first residual material determined by the controller from a cleaning efficiency point) and then direct a second pressurized cleaning solution remove a second residual material (e.g., a second residual material determined by the controller from a cleaning efficiency point) within tank 50.

In various embodiments, monitor sub-assembly 140 may include a self-cleaning device to clean the nozzle, light assembly, camera assembly, and/or one or more other components. For example, the controller may be configured to monitor nozzle 160, light assembly 170, camera assembly 180, and/or one or more other components. If the controller determines that one or more components are contaminated over a predefined threshold level, the controller may be configured to utilize a self-cleaning device to automatically clean the nozzle, light assembly, camera assembly, and/or the one or more other components.

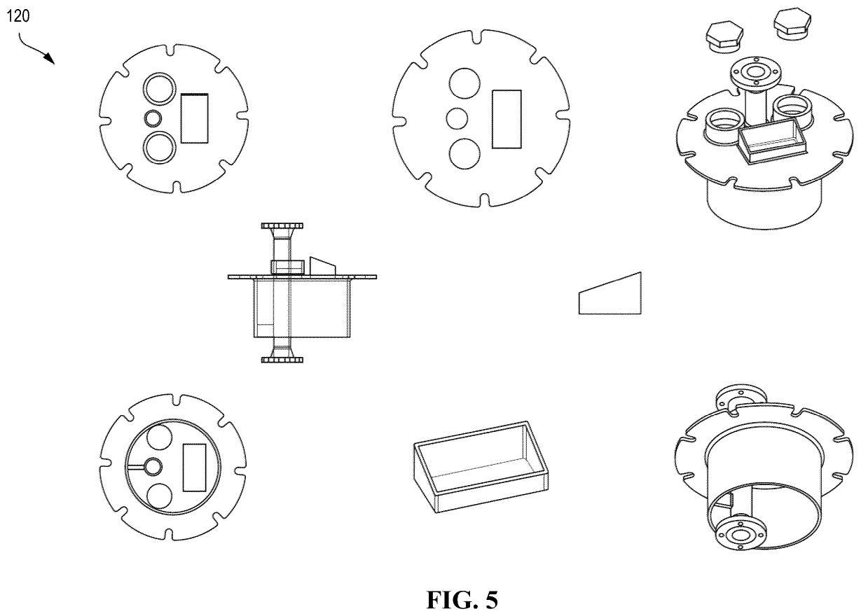

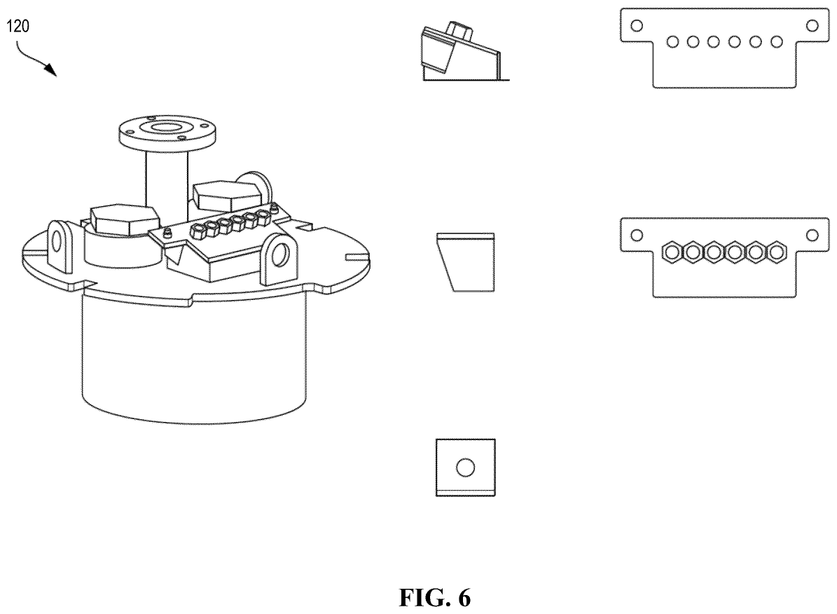

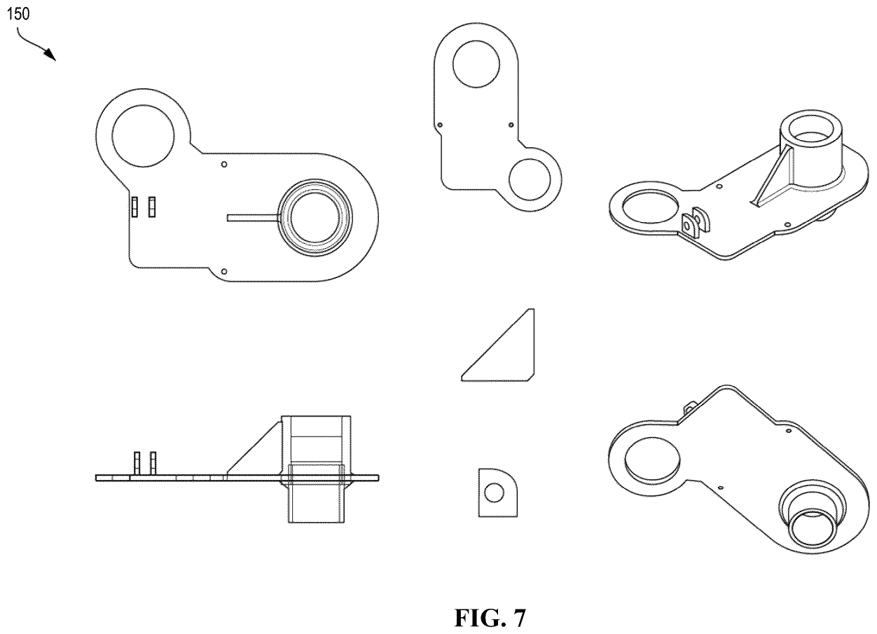

FIGS. 5-7 depict detailed views of various components of an example cannon adapter assembly 110 of integrated tank cleaning system 100, according to one or more aspects described herein. For example, FIG. 5 and FIG. 6 depict detailed views of adapter 120 of cannon adapter assembly 110 and, FIG. 7 depicts detailed views of mounting bracket 150 of cannon adapter assembly 110. The various dimensions and details included in FIGS. 5-7 are exemplary only and should not be viewed as limiting.

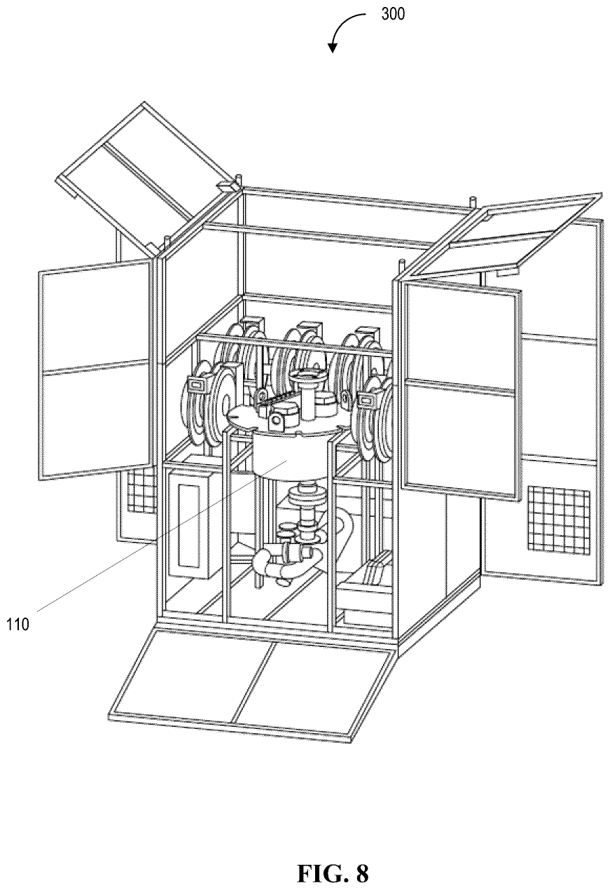

FIG. 8 depicts a perspective view of a mobile enclosure 300 for cannon adapter assembly 110, according to one or more aspects described herein. In various embodiments, mobile enclosure 300 may be the same component or similar to cannon skid 300 described further herein. In various embodiments, mobile enclosure 300 may facilitate secure transportation of cannon adapter assembly 110 within a railyard. As such, mobile enclosure 300 of integrated tank cleaning system 100 may enable cannon adapter assembly 110 to be moved to individual railroad tank cars for cleaning as opposed to requiring railroad tank cars to be moved to an equipped facility. In some embodiments, mobile enclosure 300 may include hydraulic hoses 302 that may connect cannon adapter assembly 110 to mobile enclosure 300 (or cannon skid 300) when cannon adapter assembly 110 is removably installed within a tank 50 (as depicted in FIG. 1). In other embodiments, mobile enclosure 400 may the one or more discharge hoses 202 that may connect cannon adapter assembly 110 to pressure unit skid 200 (or seacan 200) when cannon adapter assembly 110 is removably installed within a tank 50 (as depicted in FIG. 1). In some embodiments, mobile enclosure 400 may be installed in a facility and used to store cannon adapter assembly 110 when cannon adapter assembly 110 is not actively being used to clean railroad tank cars positioned within the facility.

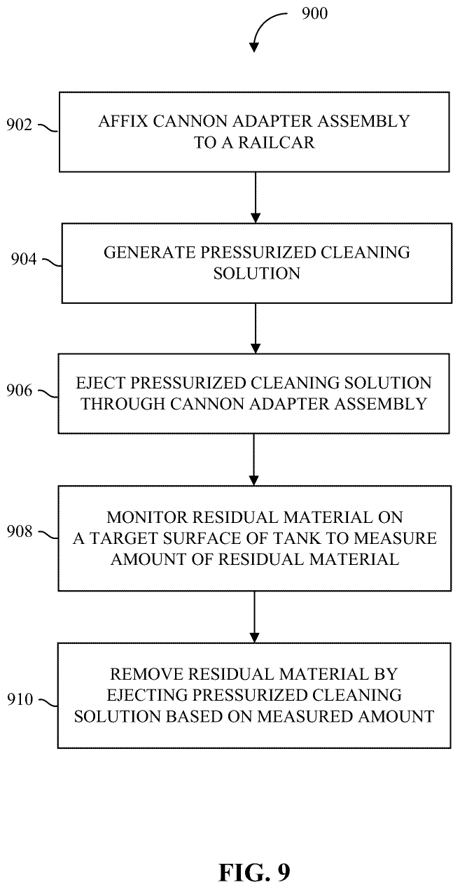

FIG. 9 illustrates an example of a process 900 for removing residual material from a railcar utilizing integrated tank cleaning system 100, according to one or more aspects described herein. The operations of process 900 presented below are intended to be illustrative and, as such, should not be viewed as limiting. In some implementations, process 900 may be accomplished with one or more additional operations not described, and/or without one or more of the operations discussed. In some implementations, two or more of the operations of process 900 may occur substantially simultaneously. The described operations may be accomplished using some or all of the system components described in detail above.

In an operation 902, process 900 may include installing cannon adapter assembly 110 of integrated tank cleaning system 100 at an opening of a tank 50 on a railroad tank car. In various embodiments, installing cannon adapter assembly 110 on tank 50 may include positioning railroad tank car cleaning system 100 within a threshold proximity of a railroad tank car having tank 50. For example, positioning the railroad tank car cleaning system 100 within a threshold proximity of a railroad tank car comprises transporting at least the cannon assembly within a railyard using a vehicle. The threshold proximity may be based on the length of one or more hoses or other components of railroad tank car cleaning system 100. In other words, the threshold proximity may simply be the maximum distance from the tank 50 that railroad tank cleaning system 100 can be in order to clean tank 50. In various embodiments, process 900 may include affixing cannon adapter assembly 110 of integrated tank cleaning system 100 to a railcar. For example, affixing cannon adapter assembly 110 of integrated tank cleaning system 100 to a railcar may comprise securing cannon assembly 110 to the tank via adapter 120 and/or one of more other components of cannon assembly 110.

In an operation 904, process 900 may include generating pressurized cleaning solution via an operating system of integrated tank cleaning system 100 for ejection through nozzle 160 of cannon adapter assembly 110. In some embodiments, prior to generating pressurized cleaning solution, process 900 may include determining one or more pre-programmed patterns or cleaning modes based, for example, on one or more of a size, a shape, and/or a material stored in tank 50. In various embodiments, determining one or more pre-programmed patterns or cleaning modes to use may include determining a cleaning profile for cleaning the interior of the tank. In some embodiments, one or more pre-programmed patterns or cleaning modes for cleaning the interior of the tank (and/or one or more cleaning profiles specifying a pre-programmed duration and/or pattern of movement for the hydraulic cannon for cleaning the interior of the tank) may be stored in electronic storage accessible by the operating system of integrated tank cleaning system 100. In some embodiments, the one or more pre-programmed patterns, cleaning modes, and/or cleaning profiles to be used may be automatically selected based on the size of tank 50, the shape of tank 50, the material stored in tank 50, and/or other information known or determined about tank 50. In other embodiments, the one or more pre-programmed patterns, cleaning modes, and/or cleaning profiles to be used may be selected via user input. For example, a controller of railroad tank car cleaning system 100 may be configured to receive user input indicating at least one cleaning profile used to automatically control movement and operation of the hydraulic cannon during cleaning. In some embodiments, prior to generating pressurized cleaning solution, process 900 may include mapping an interior contour of tank 50 by one or more vision systems, such that one or more pre-programmed patterns, cleaning modes, and/or cleaning profiles may be automatically determined by the controller based on the mapped (or learned) interior of the tank 50.

In an operation 906, process 900 may include ejecting pressurized cleaning solution through nozzle 160 into tank 50 of the railroad tank car. In various embodiments, process 900 may include a controller of railroad tank car cleaning system 100 automatically controlling movement and operation of the hydraulic cannon according to one or more pre-programmed patterns, cleaning modes, and/or cleaning profiles to clean the interior of tank 50 (e.g., when ejecting pressurized cleaning solution through nozzle 160 into tank 50). In various embodiments, process 900 may include filtering and recirculating liquid drained from tank 50 during cleaning using filtration unit 400, which may be configured to be transported between railroad tank cars with cannon assembly 110 and other components of railroad tank car cleaning system 100.

In an operation 908, process 900 may include monitoring residual material on a target surface of tank 50 to measure an amount of the residual material. For example, process 900 may include detecting residual material on an interior surface of tank 50 based on images captured by a camera of camera assembly 180. In some embodiments, process 900 may include utilize fluorescence-based imaging functionality to identify the residual material on the interior surface of tank 50.

In an operation 910, process 900 may include removing residual material by ejecting pressurized cleaning solution based on the measured amount of residual material. In some embodiments, after removing the residual material by ejecting pressurized cleaning solution, process 900 may further include adjusting one or more pre-programmed patterns or cleaning modes based on the measured amount of the residual material. In other embodiments, after removing the residual material by ejecting pressurized cleaning solution, process 900 may further include adjusting a pulsation insert or a directional insert to generate an ejection type of pressurized cleaning solution. In some embodiments, process 900 may further include extending an arm or otherwise manipulating the position of the monitor sub-assembly 140 of cannon adapter assembly 110 within tank 50.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A railroad tank car cleaning system comprising:
a cannon assembly secured to a tank of a railroad tank car at an opening of a manway hatch of the tank, the cannon assembly including an adapter configured to seal the opening of the manway hatch and a hydraulic cannon configured to extend within an interior of the tank, the hydraulic cannon comprising at least a nozzle for pressure cleaning the interior of the tank and a camera for remotely visualizing the interior of the tank; and
a controller configured to automatically control movement and operation of the hydraulic cannon during cleaning according to one or more cleaning profiles.

2. The railroad tank car cleaning system of claim 1, wherein individual cleaning profiles specify a pre-programmed duration and pattern of movement for the hydraulic cannon for cleaning the interior of the tank.

3. The railroad tank car cleaning system of claim 2, wherein the controller is configured receive user input indicating at least one cleaning profile used to automatically control movement and operation of the hydraulic cannon during cleaning.

4. The railroad tank car cleaning system of claim 2, wherein the controller is configured to automatically select at least one cleaning profile based on at least one of a size of the tank, a shape of the tank, and a material stored in the tank.

5. The railroad tank car cleaning system of claim 1, wherein the one or more cleaning profiles are stored in electronic storage accessible by the controller.

6. The railroad tank car cleaning system of claim 1, wherein the system further comprises a vehicle configured to transport the cannon assembly and the controller between railroad tank cars within a railyard.

7. The railroad tank car cleaning system of claim 6, the system further comprising a filtration unit configured to filter and recirculate liquid drained from the tank during cleaning, wherein the filtration unit is configured to be transported between railroad tank cars with the cannon assembly.

8. The railroad tank car cleaning system of claim 1, wherein the system is configured to detect residual material on an interior surface of the tank based on images captured by the camera.

9. The railroad tank car cleaning system of claim 8, wherein the system is configured to utilize fluorescence-based imaging functionality to identify the residual material on the interior surface of the tank.

10. The railroad tank car cleaning system of claim 1, wherein the system is configured to map the interior contours of the tank based on images captures by the camera and automatically selecting at least one cleaning profile based on the mapped interior contours of the tank.

11. A method for cleaning a railroad tank car without requiring a human to enter the tank car, the method comprising:
positioning a railroad tank car cleaning system within a threshold proximity of a railroad tank car, wherein the railroad tank car cleaning system comprises a cannon assembly including an adapter configured to be seal the opening of the manway hatch and a hydraulic cannon configured to extend within an interior of the tank, the hydraulic cannon comprising at least a nozzle for pressure cleaning the interior of the tank and a camera for remotely visualizing the interior of the tank;
securing the cannon assembly to the tank via the adapter;
determining a cleaning profile for cleaning the interior of the tank; and
automatically controlling movement and operation of the hydraulic cannon according to the cleaning profile to clean the interior of the tank.

12. The method of claim 11, wherein individual cleaning profiles specify a pre-programmed duration and pattern of movement for the hydraulic cannon for cleaning the interior of the tank.

13. The method of claim 12, wherein determining a cleaning profile for cleaning the interior of the tank comprises receiving user input specifying at least one cleaning profile.

14. The method of claim 12, wherein determining a cleaning profile for cleaning the interior of the tank comprises automatically selecting, by a controller, at least one cleaning profile based on at least one of a size of the tank, a shape of the tank, and a material stored in the tank.

15. The method of claim 11, wherein positioning the railroad tank car cleaning system within a threshold proximity of a railroad tank car comprises transporting at least the cannon assembly within a railyard using a vehicle.

16. The method of claim 15, the method further comprising filtering and recirculating liquid drained from the tank during cleaning using a filtration unit configured to be transported between railroad tank cars with the cannon assembly.

17. The method of claim 11, the method further comprising detecting residual material on an interior surface of the tank based on images captured by the camera.

18. The method of claim 17, the method further comprising removing the residual material on the interior surface of the tank based on an amount of residual material detected.

19. The method of claim 17, wherein the residual material on the interior surface of the tank is detected utilizing fluorescence-based imaging functionality.

20. The method of claim 11, the method further comprising mapping the interior contours of the tank based on images captures by the camera and automatically selecting at least one cleaning profile based on the mapped interior contours of the tank.
